(19) United States
(12) Patent Application Publication
(10) Pub. No.: US 2004/0197625 A1
(43) Pub. Date: Oct. 7, 2004

(54) Method and apparatus for separating water from a fuel cell exhaust stream

(75) Inventors: Vijay Anant Deshpande, Houston, TX (US); William Spencer Wheat, Missouri City, TX (US); Ralph Stanley Worsley, Brentwood Bay (CA)

Correspondence Address: ChevronTexaco Corporation, 1111 Bagby, Suite 4040, Houston, TX, 77002, US

(73) Assignee: Texaco Inc., San Ramon, CA

(21) Appl. No.: 10/407,617

(22) Filed: Apr. 4, 2003

(51) Int. Cl. H01M 8/04

(52) U.S. Cl. 429/26; 429/22; 429/13

(57) ABSTRACT

A power generating apparatus for reducing product water in a fuel cell exhaust stream. The apparatus includes a fuel cell for conducting an electrochemical reaction producing electricity and an exhaust stream comprising water, a water tank having an exhaust stream inlet connected to an exhaust stream outlet of the fuel cell, and a combustor in fluid communication with an upper portion of the water tank. A portion of the water in the exhaust stream condenses and drops out of the exhaust stream within the water tank to give a water-depleted exhaust stream that is directed to the combustor. Preferably, the water tank is connected to a source of make up water and a drain. The tank can further have level control systems for maintaining minimum and maximum levels of water within the tank. The tank may have an outlet for directed collected water to a fuel cell, fuel processing or integrated fuel cell/fuel processing system. A method for separating water from a fuel cell exhaust is also provided.

### FIELD OF THE INVENTION

The present invention relates to a fuel cell apparatus for converting a hydrogen-enriched fuel into usable power. More specifically, the present invention provides methods and apparatus for reducing product water in a fuel cell exhaust stream.

### BACKGROUND OF THE INVENTION

Fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is proportional to the consumption rate of these reactants.

A significant disadvantage which inhibits the wider use of fuel cells is the lack of a widespread hydrogen infrastructure. Hydrogen has a relatively low volumetric energy density and is more difficult to store and transport than hydrocarbon fuels currently used in most power generation systems. One way to overcome this difficulty is the use of reformers to convert a hydrocarbon fuel to a hydrogen rich gas stream that can be used as a feed for fuel cells.

Hydrocarbon-based fuels, such as natural gas, LPG, gasoline, and diesel, require conversion processes to be used as fuel sources for most fuel cells. Current art uses multi-step processes combining an initial conversion process with several clean-up processes. The initial process is most often steam reforming (SR), autothermal reforming (ATR), catalytic partial oxidation (CPOX), or non-catalytic partial oxidation (POX) or combinations thereof. The clean-up processes are usually comprised of a combination of desulphurization, high temperature water-gas shift, low temperature water-gas shift, selective CO oxidation, selective CO methanation or combinations thereof. Alternative processes for recovering a purified hydrogen-rich reformate include the use of hydrogen selective membrane reactors and filters.

A fuel cell produces water as a product of the electrochemical reaction that occurs within the cell. Efficient operation of a fuel cell/fuel processing system depends on the ability to provide effective water management in the system and specifically to control the recovery of water in the system. Therefore, it is desirable to continually recover fuel cell product water so that it can be used for other purposes within the fuel cell system such as to provide water to a fuel processor and/or the fuel cell stack. It is also desirable to minimize the amount of water in the fuel cell exhaust stream so as not to detrimentally affect reactors supplied by such streams. For example, fuel cell exhaust streams are typically eliminated from such systems by catalytically combusting them in a combustor or oxidizer. The amount of product water in such fuel cell exhaust gases should be reduced so as to reduce the likelihood that the combustor catalyst will be drowned or that the combustion process will otherwise be suppressed.

Another product of the electrochemical reaction occurring within the fuel cell is heat. The heat generated during the reaction tends to convert the product water to steam and water vapor. As the fuel cell exhaust is directed away from the fuel cell it is common to treat the exhaust stream in a heat exchanger, condenser, cooler or similar apparatus for converting the water vapor and steam to liquid water. Optionally, a separator may be used for separating the liquid water from the exhaust stream so that the liquid water may be collected in a tank or reservoir. However, the cooling of the exhaust gases that occurs in such processes may be undesirable as heat recovery is a common and desirable element of such systems. In addition, it has been found that the condensing, separating and collecting of liquid water in separate process modules or devices can lead to problems of clogging, corrosion and other maintenance issues in the lines connecting such devices. Further still, conventional water separation methods and devices can impose a significant pressure drop on the subject gas stream.

The present invention relates to simplified methods and apparatus for efficiently reducing the product water in a fuel cell exhaust stream without imposing a significant pressure drop on such streams.

### SUMMARY OF THE INVENTION

The present invention provides a power generating apparatus for reducing product water in a fuel cell exhaust stream. The apparatus comprises a fuel cell for conducting an electrochemical reaction producing electricity and an exhaust stream comprising water. The fuel cell has at least one exhaust stream outlet. The power generating apparatus further includes a water tank having an exhaust stream inlet connected to the exhaust stream outlet of the fuel cell. In addition, the apparatus includes a combustor in fluid communication with an upper portion of the water tank.

A portion of the water in the exhaust stream condenses and separates from the exhaust stream within the water tank to give a water-depleted exhaust stream that is directed to the combustor. The combustor can be integrated with a fuel processing apparatus. Preferably, the exhaust stream inlet is located on the upper portion of the water tank and the exhaust stream outlet of the fuel cell is elevated relative to the water tank. In the alternative, the exhaust stream outlet of the fuel cell can be connected to the water tank via a conduit wherein at least a portion of the conduit is elevated relative to the exhaust stream inlet.

Preferably, the water tank includes a make-up water inlet and a first level control system for preventing the liquid water within the tank from exceeding a pre-selected maximum level. The first level control system can include a first level switch on a side wall of the water tank, an inlet valve connected to the make-up water inlet, and a first actuator connected to the first level switch for actuating the inlet valve. Optionally but preferably, the first level switch can include a float for moving the switch between open and closed positions.

In addition, it is preferred that the water tank include a drain outlet and a second level control system for preventing the liquid water within the tank from falling below a pre-selected minimum level. The second level control system can include a second level switch on a side wall of the water tank, a drain valve connected to the drain outlet, and a second actuator connected to the second level switch for actuating the drain valve. Optionally, the second level switch can include a float for moving the switch between open and closed positions. The drain outlet is preferably in fluid communication with a domestic drain. In addition, it is preferred that the water tank include a liquid water outlet to provide process water to a fuel processor, a fuel cell or an integrated fuel processor/fuel cell apparatus.

Optionally, the water tank can include an air inlet that allows air into the water tank. An enclosure for housing the water tank and a fuel processing apparatus and/or a fuel cell can also be provided.

In a process aspect of the present invention, a method for separating product water from a fuel cell exhaust is provided. The method includes the steps of operating a fuel cell to generate electricity and at least one exhaust comprising water, condensing the water from the exhaust within a process water tank to obtain a water-depleted exhaust, and combusting the water-depleted exhaust in a combustor. The method can further include the step of draining water from the water tank while preventing the liquid water from falling below a pre-selected minimum level of water within the water tank to prevent exhaust from passing out of a drain outlet. Similarly, the method can include the step of adding make-up water to the water tank while preventing the liquid water from exceeding a maximum level of water within the water tank. Additional optional but preferred steps include allowing air to enter the water tank and directing liquid water out of the water tank for use in a fuel cell and/or fuel processor.

The present invention further provides a power generating apparatus for reducing product water in a fuel cell exhaust stream. The apparatus includes a fuel cell for conducting an electrochemical reaction producing electricity and an exhaust stream comprising water. The fuel cell has at least one exhaust stream outlet. The power generating apparatus further includes a water tank having an exhaust stream inlet connected to the exhaust stream outlet of the fuel cell. In addition, the apparatus includes a combustor in fluid communication with an upper portion of the water tank. The product water in the exhaust stream condenses from exhaust stream within the water tank to give a water-depleted exhaust stream that is directed to the combustor. The apparatus preferably does not include means for causing the product water to condense and separate from the exhaust stream upstream from the exhaust stream inlet.

### BRIEF DESCRIPTION OF THE DRAWINGS

The invention may be understood by reference to the following description taken in conjunction with the accompanying drawings.

FIG. 1 is a schematic diagram of an apparatus of the present invention for separating product water from a fuel cell exhaust gas stream.

FIG. 2A is a side view of a level switch suitable for use in an apparatus of the present invention.

FIG. 2B is a side view of a level switch suitable for use in an apparatus of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routing undertaking for those of ordinary skill in the art having the benefit of this disclosure.

The present invention provides (1) a power generating apparatus for reducing product water in a fuel cell exhaust stream, (2) a method for separating product water from a fuel cell exhaust, and (3) a power generating apparatus for reducing product water in a fuel cell exhaust stream.

(1) A Power Generating Apparatus For Reducing Product Water in a Fuel Cell Exhaust Stream

A preferred embodiment of the present invention is a power generating apparatus comprising a fuel cell for conducting an electrochemical reaction producing electricity and an exhaust stream comprising product water, the fuel cell having at least one exhaust stream outlet; a water tank having an exhaust stream inlet connected to the exhaust outlet of the fuel cell; and a combustor in fluid communication with an upper portion of the water tank. A portion of the product water in the exhaust stream condenses and separates from the exhaust stream within the water tank to yield a water-depleted exhaust stream that is directed to the combustor.

Fuel Cell Stack

A power generating apparatus of the present invention comprises at least one fuel cell for conducting an electrochemical reaction that produces electricity and an exhaust stream comprising water.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H_{2·}→2H⁺+2e⁻ (1)

at the anode of the cell, and

O₂+4H⁺+4e⁻→2H₂O (2)

at the cathode of the cell.

A typical fuel cell has a terminal voltage of up to about one volt DC. For purposes of producing much larger voltages, multiple fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow field plates (graphite composite or metal plates, as examples) that are stacked one on top of the other. The plates may include various surface flow field channels and orifices to, as examples, route the reactants and products through the fuel cell stack. The flow field plates are generally molded, stamped or machined from materials including carbon composites, plastics and metal alloys. A PEM is sandwiched between each anode and cathode flow field plate. Electrically conductive gas diffusion layers (GDLs) may be located on each side of each PEM to act as a gas diffusion media and in some cases to provide a support for the fuel cell catalysts. In this manner, reactant gases from each side of the PEM may pass along the flow field channels and diffuse through the GDLs to reach the PEM. The GDLs generally comprise either a paper or cloth based on carbon fibers. The PEM and its adjacent pair of catalyst layers are often referred to as a membrane electrode assembly (MEA). An MEA sandwiched by adjacent GDL layers is often referred to as a membrane electrode unit (MEU), or also as an MEA. Common membrane materials include NAFION™, GORE SELEC™, sulphonated fluorocarbon polymers, and other materials such as polybenzimidazole (PBI) and polyether ether ketone. Various suitable catalyst formulations are also known in the art, and are generally platinum-based.

Preferably, the power generating apparatus will have a plurality of fuel cells connected in series as a fuel cell stack. Fuel cell stacks also typically employ one or more manifolds for connecting common feed streams to the individual cells and for connecting the multiple anode and cathode exhaust outlets to one or more common exhaust streams. In the power generation apparatus of the present invention, the fuel cell or fuel cell stack has at least one exhaust stream outlet for connecting with the exhaust stream inlet of a process water tank. The exhaust stream preferably comprises a cathode exhaust stream but may also comprise an anode exhaust stream.

The fuel cell stack is preferably elevated relative to the process water tank so that the exhaust stream travels down a gradient to reach the tank. In the alternative, perhaps where it is not desirable to locate the fuel cell at a position that is elevated relative to the water tank, at least a portion of the conduit that connects the fuel cell exhaust stream outlet to the exhaust stream inlet of the water tank should be elevated relative to the water tank. Again, this configuration of the conduit insures that the exhaust stream travels down a gradient as it approaches the water tank exhaust inlet. By providing such a gradient in or about the exhaust stream inlet of the process water tank, any condensation that might occur outside the tank will not collect within the conduit but will flow toward the tank under the influence of gravity. Thus, water collection and potential clogging within the conduits are avoided.

In addition, the fuel cells and fuel cell stacks used in the power generating apparatus of the present invention can also have an inlet for receiving a stream of water or other cooling fluid for circulating through the stack and to control the temperature of the fuel cell during the electrochemical reaction.

Similarly, it is envisioned that the fuel cell stack can be housed within a common enclosure with the process water tank, with or without an associated fuel processing apparatus. Descriptions of suitable enclosures may be obtained by reference to U.S. Pat. No. 6,080,500 issued Jun. 27, 2000 to Fuju, et al.; U.S. Pat. No. 6,183,895 issued Feb. 6, 2001 to Kudo, et al.; International Patent Application Publication No. WO 01/59861, published Aug. 16, 2001; U.S. patent application Publication No. 2002/0119354 A1, published Aug. 29, 2002; and U.S. patent application Publication No. 2003/0044663 A1, published Mar. 6, 2003. The description of each of these references is incorporated herein by reference. A preferred enclosure is described in U.S. application Ser. No. ______ “Portable Fuel Processor Apparatus and Enclosure and Method of Installing Same,” to Wheat, et al., filed Apr. 4, 2003 (Attorney Docket No. X-0130), the disclosure of which is incorporated herein by reference.

Process Water Tank

As noted above, a power generating apparatus of the present invention includes a process water tank for receiving, condensing and separating product water from a fuel cell exhaust stream. The water-depleted exhaust stream is then directed to a combustor for combustion.

The fuel cell exhaust stream comprising product water enters the process water tank through an exhaust stream inlet that is in fluid communication with the exhaust stream outlet of a fuel cell. The exhaust stream inlet on the water tank should be on an upper portion of the process water tank. As used herein, “upper portion” of the process water tank refers to any portion of the tank that is above the water line. A first level control system is described below that can prevent the water level from exceeding a pre-selected maximum level. Where such a control system is employed, the “upper portion” of the tank refers to that portion of a process water tank that is above the pre-selected maximum water level.

Preferably, no apparatus or device is employed between the water tank and the fuel cell for the purpose of cooling, condensing or separating the product water from the fuel cell exhaust stream. The exhaust stream and product water are delivered directly to the inlet of the process water tank. Again, it is believed that the use of individual devices for condensing and/or separating product water from a fuel cell exhaust stream upstream from a water collection tank or reservoir can lead to the collection of condensation within the connecting conduits and potentially the clogging and/or corrosion of such conduits over time. Therefore, it is preferred that the product water condense and separate from the exhaust stream within the process water tank itself, rather than at a point upstream from the exhaust stream inlet of the water tank. It is envisioned that devices used for purposes other than cooling, condensing or separating the product water from the fuel cell exhaust stream can be employed intermediate between the fuel cell stack and water tank.

Temperature and pressure conditions within the process water tank are maintained so as to promote the condensing of product water from the exhaust stream. As the product water condenses within the process water tank, it separates from the exhaust stream gases and collects in a lower portion of the tank under the influence of gravity.

A source of make-up water can be connected to the water tank through a make-up water inlet. In addition, a first level control system for preventing the liquid water within the tank from exceeding a pre-selected maximum level can be used. Specifically, the first level control system can include a first level switch mounted to an inner surface of a side wall of the tank, an inlet valve connected to the make-up water inlet and a first actuator connected to the first level switch for actuating the inlet valve. Preferably, the level switch is an electronic switch comprising a float for moving the switch between open and closed positions. A magnetic contactor may be connected to the float for creating and breaking a circuit within the switch electronics. Further still, the actuator, may be a solenoid electrically connected to the switch in series from moving the valve from a normally open position to a closed position. As the water level in the tank rises, the float rises moving the switch from a normally open position to a closed position. In such a configuration, the closed position completes the circuit causing the solenoid to close the make-up water inlet valve. As the water level within the tank falls, the float falls moving the magnetic contactor from a closed to an open position breaking the circuit and enabling the solenoid to return the inlet valve to its normally open position.

A drain is connected to a lower portion of the water tank for releasing a flow of water from the tank to a domestic drain. The drain comprises an outlet and a second level control system for preventing the liquid water within the tank from falling below a minimum level. The maintenance of a minimum level of water above the drain outlet is critical in that this water forms a water seal within the process water tank. This water seal prevents fuel cell exhaust gases from escaping through the drain outlet and further aids in maintaining substantially the same pressure within the water tank as is present in the fuel cell, the combustor and the interconnecting lines. As such, the exhaust stream does not experience a significant pressure drop as the stream passes through the water tank and product water is separated.

The second level control system may comprise a float valve having a float connected but spaced apart from a valve seat. As the water level within the tank drops, the float and the connected valve seat drop completing a seal before the water completely drains from the tank. In a preferred embodiment, the second level control system includes a second level switch mounted to an inner surface of a side wall of the tank below the first level switch, an outlet valve connected to the drain outlet and a second actuator connected to the second level switch for actuating the drain outlet valve. Preferably, the second level switch is an electronic switch comprising a float for moving the switch between open and closed positions. A magnetic contactor may be connected to the float for creating and breaking a circuit within the switch electronics. Further still, the actuator can be a solenoid electrically connected to the switch in series for moving the valve from a normally open position to a closed position. As the water level in the tank drops, the float drops moving the switch from an open to a closed position. In this configuration, the closed position completes the circuit causing the solenoid to close the normally open valve. As the water level within the tank rises, the float rises moving the magnetic contractor from a closed to an open position breaking the circuit and enabling the solenoid to return the outlet valve to its open position.

Optionally, the first and second level control systems may be connected with a process control unit that controls the operation of the make-up inlet valve and the drain outlet valve. In such an embodiment, the first and second level switches are replaced with level sensors that send data to the process control unit. The process control unit then determines the appropriate positions of the make-up inlet and drain outlet valves and generates one or more signals that are sent to the actuators to actuate the valves to the appropriate positions. Suitable level control systems having a process control unit are described in U.S. patent application Ser. No. ______, “Method and Apparatus for Level Control in a Water Tank for a Fuel Cell Reformer,” Wheat, et al., filed Apr. 4, 2003 (Attorney Docket No. X-0128), the disclosure of which is incorporated herein by reference.

Optionally, the process water tank can have one or more outlets for directing liquid water to a fuel cell, a fuel processing apparatus or an integrated fuel cell/fuel processing apparatus. In addition, an air inlet can be provided for allowing air to flow into an upper portion of the water tank, while providing that gases within the water tank are not able to flow out of the tank. A check valve or the like at this air inlet is suitable for this purpose.

After the product water has been condensed and separated from the fuel cell exhaust stream, the water-depleted exhaust gases are directed out of the tank to a combustor. Thus, an exhaust gas outlet can be provided on the water tank that is in fluid communication with a combustor. When present, this gas outlet should be provided on an upper portion of the water tank to prevent liquid water within the tank from being drawn into the combustor.

In a preferred embodiment, the water tank is housed within a common enclosure with a fuel processing apparatus. Fuel processors are well known in the art for converting hydrocarbon based fuels into a hydrogen-rich reformate of fuel cell quality. A preferred enclosure is described in U.S. application Ser. No. ______ “Portable Fuel Processor Apparatus and Enclosure and Method of Installing Same,” to Wheat, et al., filed Apr. 4, 2003 (Attorney Docket No. X-0130) the disclosure of which is incorporated herein by reference.

Combustor

The power generating apparatus of the present invention comprises a combustor in fluid communication with an upper portion of the process water tank for receiving the water-depleted exhaust gases from the tank.

Combustors are well known in the art and are used in association with fuel processing and fuel cell systems for a variety of functions including the heating of reactants, the generation of steam, the heating of one or more reactors and/or catalyst beds, and the disposal of undesirable by-products that are generated during the operation of such systems. For instance, such combustors are frequently referred to as tail gas oxidizers since they are commonly used to combust tail gas from the fuel cell stack in addition to other functions that they may provide.

In the methods and apparatus of the present invention it is preferred that a combustor be utilized to combust, and thereby eliminate exhaust streams from a fuel cell or fuel cell stack. Such gas streams typically comprise combustible gases such as unreacted hydrogen and oxygen and inerts such as spent fuel(s), spent air and other products. Such gases cannot be disposed with the product water nor or simply vented from the system. Further, the combustion of such gases can provide benefits to the system. For instance, improved control over the operation of the combustor may be obtained by directing inert gases such as are found in the cathode exhaust into the combustor. These inert gases provide improved temperature control over the combustor in the form of a lower more uniform temperature profile. In addition, improved efficiencies in the operation of the combustor may be obtained by directing the combustible gases in the fuel cell exhaust streams to the combustor as well.

Suitable combustors can include those disclosed in U.S. Pat. No. 6,077,620, issued Jun. 20, 2000 to Pettit (catalytic combustor fired by anode effluent and/or fuel from a liquid fuel supply that has been vaporized); U.S. Pat. No. 6,232,005, issued May 15, 2001 to Pettit (a tubular section at the combustor's input end intimately mixes the anode and cathode effluents before they contact the combustors primary catalyst bed; the tubular section comprises at least one porous bed of mixing media that provides a tortuous path for creating turbulent flow and intimate mixing of the anode and cathode effluents therein); and U.S. Pat. No. 6,342,197, issued Jan. 29, 2002 to Senetar, et al. (describing and comparing combustors with a variety of features and configurations), the disclosures of which are incorporated herein by reference. Other suitable combustors include those described in U.S. patent application Ser. No. ______ “Method and Apparatus for Rapid Heating of Fuel Reforming Reactants” to Nguyen, filed Apr. 4, 2003 (Attorney Docket No. X-0076), and in U.S. patent application Ser. No. ______ “Anode Tailgas Oxidizer” to Deshpande, et al., filed Apr. 4, 2003 (Attorney Docket No. X-0075), the disclosures of which are incorporated herein by reference.

Preferred combustors include those that are integrated with a fuel processing unit. As such it is envisioned that the combustor will likewise be housed within a common enclosure with the fuel processor and process water tank. Examples of suitable enclosures for fuel processing systems are provided above.

Optional Systems and Subsystems

The power generating apparatus of the present invention can further include a fuel processing system for converting a hydrocarbon-based fuel to hydrogen-rich reformate. The hydrogen-rich reformate is directed to the fuel cell stack for use as a reactant in an electrochemical reaction. Fuel reformers or processors are well known in the art. Suitable reformers include but are not limited to those described in U.S. patent application Publication Nos.: US 2002/0083646 A1 to Deshpande, et al., published Jul. 4, 2002; US 2002/0090326 A1 to Deshpande, published Jul. 11, 2002; US 2002/0090328 A1 to Deshpande, published Jul. 11, 2002; US 2002/0090327 A1 to Deshpande, published Jul. 11, 2002; US 2002/0088740 A1 to Krause, et al., published Jul. 11, 2002; US 2002/0094310 A1, to Krause, et al., published Jul. 18, 2002; US 2002/0155329 A1 to Stevens, published Oct. 24, 2002; US 2003/00211741 A1 to Childress, et al., published Jan. 30, 2003; and US 2003/0021742 to Krause, et al., published Jan. 30, 2003; the disclosure of each of which is incorporated herein by reference. These publications disclose a number of differently configured fuel processors that may be used to advantage in a power generating apparatus of the present invention.

A number of other subsystems can be integrated with a reformer and combustor. Such subsystems can include air handling, cooling and water management subsystems that may optionally be packaged or enclosed within a common enclosure with the fuel reformer and/or combustor. Examples of such systems may be found in U.S. patent application Ser. No. ______, “Fluid Balance Control System for Use in a Fuel Processor,” Nguyen, et al., filed Apr. 4, 2003 (Attorney Docket No. X-0072); U.S. patent application Ser. No. ______, “Coolant System for Fuel Processor,” Wheat, et al., filed Apr. 4, 2003 (Attorney Docket No.X-0125); and U.S. patent application Ser. No. ______ “Portable Fuel Processor Apparatus and Enclosure and Method of Installing Same,” to Wheat, et al., filed Apr. 4, 2003 (Attorney Docket No. X-0123); the disclosures of which are all incorporated herein by reference.

Water management subsystems typically include a separator for removing water from a process gas stream. As noted above, the fuel cell exhaust stream that is directed into the process water tank can be the cathode and/or anode exhaust streams. If only one of these streams is conveyed directly from the fuel cell to the process water tank, the other stream may be processed by passing it through a water separation device to remove product water. Such separators are particularly useful where a fuel processing system is present, as the reformate produced by such fuel processors typically contains excess water that must be reduced or eliminated before the hydrogen-rich reformate is delivered to the fuel cell stack.

Suitable separators include mechanical separators as well as other conventional gas-liquid separators. For instance, gas-liquid separators having filters and membranes for use in separating stream components are disclosed in U.S. Pat. No. 3,224,173, issued Dec. 21, 1965 to Webb; U.S. Pat. No. 5,989,318, issued Nov. 23, 1999 to Schroll; U.S. Pat. No. 6,376,113 issued Apr. 23, 2002 to Edlund, et al.; and U.S. Pat. No. 6,228,146, issued May 8, 2001 to Kuespert. In addition, gas-liquid separators that utilize condensers and water traps to separate water from streams are disclosed in U.S. Pat. No. 4,037,024, issued Jul. 19, 1977 to Landau; U.S. Pat. No. 6,432,568, issued Aug. 13, 2002 to Salvador, et al.; U.S. Pat. No. 5,366,818, issued Nov. 22, 1994 to Wilkinson, et al.; and U.S. patent application Publication No. 2003/0044670 A1, published Mar. 6, 2003. The disclosure of each of these patents and patent publications is incorporated herein by reference. A preferred separator is described in U.S. patent application Ser. No. ______, “Method and Apparatus for Separating Liquid From a High Pressure Gas Stream,” Wheat, et al., filed Apr. 4, 2003 (Attorney Docket No. X-0129).

(2) A Method for Separating Product Water From a Fuel Cell Exhaust

In a process aspect of the present invention, a method for separating product water from a fuel cell exhaust is provided. The method includes the steps of operating a fuel cell to generate electricity and at least one exhaust stream comprising water, condensing the water from the exhaust stream within a process water tank to obtain a water-depleted exhaust stream, and combusting the water-depleted exhaust stream in a combustor. The method can further include the step of draining water from the water tank while maintaining a minimum level of water within the water tank to prevent exhaust from passing out of the tank through a drain outlet. Similarly, the method can include the step of adding make-up water to the water tank while maintaining a maximum level of water within the water tank. Additional optional but preferred steps include allowing air to enter the water tank and directing liquid water out of the water tank for use in a fuel cell and/or a fuel processor.

(3) A Power Generating Apparatus for Reducing Product Water in a Fuel Cell Exhaust Stream

The apparatus includes a fuel cell for conducting an electrochemical reaction producing electricity and an exhaust stream comprising water. The fuel cell has at least one exhaust stream outlet. The power generating apparatus further includes a water tank having an exhaust stream inlet connected to the exhaust stream outlet of the fuel cell. In addition, the apparatus includes a combustor in fluid communication with an upper portion of the water tank. The exhaust stream is not treated upstream from the exhaust stream inlet to cause the product water to condense and separate from the exhaust stream, but rather, the product water condenses and separates out of the exhaust stream within the water tank to give a water-depleted exhaust stream that is directed to the combustor.

### DETAILED DESCRIPTION OF THE FIGURES

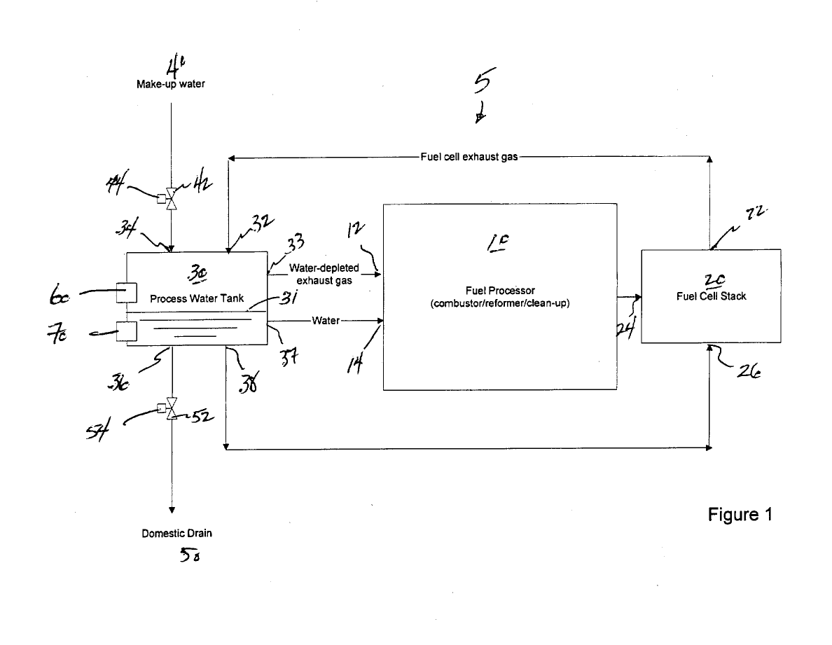

FIG. 1 is a schematic illustration of a power generating apparatus 5 of the present invention comprising a fuel cell stack 20, a process water tank 30 and fuel processor 10. Fuel processor 10 is intended to represent not only a fuel reformer, but an integrated combustor and the various post-reforming stages that may be utilized to obtain a hydrogen-rich reformate of fuel cell quality. Thus, it is envisioned that fuel processor 10 will also include a shift reactor or module and desulfurization and carbon monoxide removal among other potential modules.

The hydrogen-rich reformate generated by fuel processor 10 is directed to fuel cell stack 20 through inlet 24. The reformate is used as a reactant in an electrochemical reaction to produce electricity and an exhaust stream. The exhaust stream comprises product water, but may also include spent reformate, unreacted hydrogen, spent air or other oxygen-containing gases, and unreacted oxygen. As described above, the exhaust stream can comprise exhaust gases from the cathode and/or anode side of the fuel cells in fuel cell stack 20. Preferably, the fuel cell exhaust stream will comprise the cathode exhaust stream.

The exhaust stream exits the fuel cell stack through outlet 22 and is directed into process water tank 30 through exhaust stream inlet 32. Within process water tank 30, the product water within the exhaust stream condenses, separates out from the exhaust gases and collects as liquid water 31 in the lower portion of water tank 30. The water-depleted exhaust gases in the upper portion of water tank 30 flow out of the tank through outlet 33 and into a combustor integrated with fuel processor 10. The integrated combustor has inlet 12 that is in fluid communication with the enclosed upper portion of water tank 30. The water-depleted exhaust gases are combusted or completely oxidized within the combustor.

Water tank 30 is connected to a source of fresh make-up water 40 via make-up inlet 34. A first level control system is provided for preventing the liquid water level within the tank from exceeding a pre-selected maximum level. The first level control system includes inlet valve 42 for controlling the flow of make-up water from source 40 into water tank 30. The system further includes actuator 44 that is associated with inlet valve 42 for controlling the position of inlet valve 42. In addition, first level switch 60 is provided on the side wall of water tank 30 at a pre-selected maximum level for controlling actuator 44 and thereby the position of inlet valve 42.

Water tank 30 is connected to drain 50 through drain outlet 36. A second level control system is provided for preventing the liquid water level within the tank from falling below a pre-selected minimum level. The second level control system includes drain outlet valve 52 for controlling the flow of collected water from water tank 30 to drain 50. The system further includes actuator 54 that is associated with drain outlet valve 52 for controlling the position of drain outlet valve 52. In addition, second level switch 70 is provided on the side wall of water tank 30 at a pre-selected minimum level below first level switch 60 for controlling actuator 54 and thereby the position of inlet valve 52.

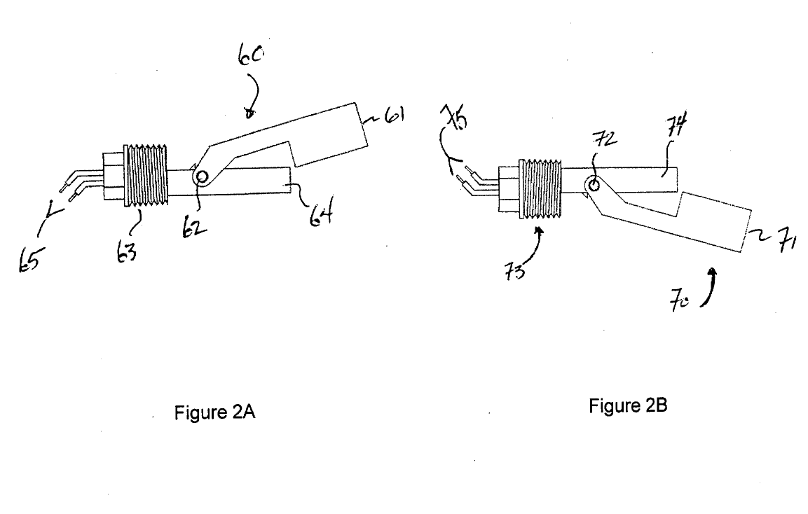

Level switches 60 and 70 are illustrated in greater detail in FIGS. 2A and 2B. Specifically, level switch 60 has a float 61 that is pivotably connected to switch housing 64 by hinge 62. Threads 63 are provided on the housing for securing level switch 60 to the side wall of water tank 30 approximate the pre-selected maximum water level. Within housing 64 are magnetic contactor and other switch electronics (not shown). The magnetic contractor is connected to float 61 and moves between open and closed positions. Actuator 44 (FIG. 1) is electrically connected with switch 60 in series via insulated conductors 65. As the water within tank 30 rises, float 61 rises to move the magnetic contactor within housing 64 from an open to a closed position creating a circuit. By completing the circuit, the solenoid actuates to close inlet valve 42. Alternatively, the switch electronics may be reversed so that the circuit is broken by the movement of float 61 and the breaking of this circuit allows the solenoid to close valve 42.

Similarly, level switch 70 is used to prevent the water level within tank 30 from falling below a pre-selected level. Level switch 70 has a float 71 that is pivotably connected to switch housing 74 by hinge 72. Threads 73 are provided on the housing for securing level switch 70 to the side wall of water tank 30 approximate the pre-selected minimum water level. Within housing 74 are magnetic contactor and other switch electronics (not shown). The magnetic contractor is connected to float 71 and moves between open and closed positions. Actuator 54 (FIG. 1) is electrically connected with switch 70 in series via insulated conductors 75. As the water within tank 30 falls below the pre-selected minimum level, float 71 falls moving the magnetic contactor from an open to a closed position creating a circuit and actuating the solenoid to close inlet valve 52. Alternatively, the switch electronics may be reversed so that the circuit is broken by the movement of float 71, and the breaking of this circuit allows solenoid 54 to close valve 42.

In addition to drain outlet 36, water tank 30 can have outlet 37 for providing process water to fuel processor 10. Fuel processors can require water for a variety of purposes such as for use in generating steam for a steam reforming reaction, for use in a water gas shift reaction and for use as a circulating cooling medium in the various reactors and catalyst beds. As such, outlet 37 can be connected with inlet 14 for delivering process water to fuel processor 10.

In addition, water tank 30 can further include outlet 38 connected with inlet 26 for providing a stream of process water to a fuel cell stack. Fuel cells can require a source of water for use in humidifying feed streams and for use as a circulating cooling medium within the cell stack.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A power generating apparatus for reducing product water in a fuel cell exhaust stream, the apparatus comprising:
a fuel cell for conducting an electrochemical reaction producing electricity and an exhaust stream comprising water, the fuel cell having at least one exhaust stream outlet;
a water tank having an exhaust stream inlet connected to the exhaust stream outlet of the fuel cell; and
a combustor in fluid communication with an upper portion of the water tank,
wherein a portion of the water in the exhaust stream condenses and separates out of the exhaust stream within the water tank to yield a water-depleted exhaust stream that is directed to the combustor.

2. The apparatus of claim 1, wherein the water tank further comprises a make-up water inlet and a first level control system for preventing the water level within the water tank from exceeding a pre-selected maximum level.

3. The apparatus of claim 2, wherein the first level control system comprises a first level switch on a side wall of the water tank, an inlet valve connected to the make-up water inlet, and a first actuator connected to the first level switch for actuating the inlet valve.

4. The apparatus of claim 3, wherein the first level switch comprises a float for moving the switch between open and closed position.

5. The apparatus of claim 1, wherein the water tank further comprises a drain outlet and a second level control system for preventing the water level within the tank from falling below a pre-selected minimum level.

6. The apparatus of claim 5, wherein the second level control system comprises a second level switch on a side wall of the water tank, a drain valve connected to the drain outlet, and a second actuator connected to the second level switch for actuating the drain valve.

7. The apparatus of claim 5, wherein the second level switch comprises a float for moving the switch between open and closed position.

8. The apparatus of claim 1, wherein the water tank further comprises an air inlet to allow air into the water tank.

9. The apparatus of claim 1, wherein the water tank further comprises a liquid water outlet to provide water to a fuel processor, a fuel cell or a fuel processor and a fuel cell.

10. The apparatus of claim 1, wherein the combustor is integrated with a fuel processing apparatus.

11. The apparatus of claim 10, further comprising a housing enclosing the water tank and fuel processing apparatus.

12. The apparatus of claim 1, further comprising a housing enclosing the water tank and a fuel cell.

13. The apparatus of claim 1, wherein the water tank further comprises a drain outlet in fluid communication with a domestic drain.

14. The apparatus of claim 1, wherein the exhaust stream outlet of the fuel cell is elevated relative to the water tank.

15. The apparatus of claim 1, wherein the exhaust stream outlet of the fuel cell is connected to the water tank via a conduit, a least a portion of the conduit is elevated relative to the water tank.

16. The apparatus of claim 1, wherein the exhaust stream inlet is on the upper portion of the water tank.

17. The apparatus of claim 1, wherein the exhaust stream comprises a cathode exhaust.

18. A method for separating water from a fuel cell exhaust, the method comprising the steps of:
operating a fuel cell to generate electricity and at least one exhaust comprising water;
condensing water from the exhaust within a process water tank to obtain a water-depleted exhaust; and
combusting the water-depleted exhaust in a combustor.

19. The method of claim 18, further comprising the step of draining water from the water tank while maintaining a minimum level of water within the water tank to prevent exhaust from passing out of a drain outlet.

20. The method of claim 18, further comprising the step of adding make-up water to the water tank while maintaining a maximum level of water within the water tank.

21. The method of claim 18, further comprising the step of allowing air to enter the tank.

22. The method of claim 18, further comprising the step of directing liquid water out of the water tank for use in a fuel cell.

23. The method of claim 18, further comprising the step of directing liquid water out of the water tank for use in a fuel processor.

24. A power generating apparatus for reducing product water in a fuel cell exhaust stream, the apparatus comprising:
a fuel cell for conducting an electrochemical reaction producing electricity and an exhaust stream comprising product water;
a water tank in fluid communication with the fuel cell for receiving the exhaust stream, the water tank having an exhaust stream inlet; and
a combustor in fluid communication with an upper portion of the water tank,
wherein the product water in the exhaust stream condenses from exhaust stream within the water tank to give a water-depleted exhaust stream that is directed to the combustor, and further provided that the exhaust stream is not treated to cause the product water to condense and separate from the exhaust stream upstream from the exhaust stream inlet.
